(19) United States
(12) Patent Application Publication
(10) Pub. No.: US 2016/0039986 A1
(43) Pub. Date: Feb. 11, 2016

(54) METHOD FOR CONTINUOUS PMI FOAM PRODUCTION

(71) Applicant: Cornelia ZIMMERMANN, (US)

(72) Inventors: Rainer ZIMMERMANN, Seeheim-Jugenheim (DE); Florian BECKER, Darmstadt (DE); Wilfried HEBERER, Reichelsheim (DE)

(73) Assignee: EVONIK ROEHM GMBH, Darmstadt (DE)

(21) Appl. No.: 14/781,797

(22) PCT Filed: Mar. 12, 2014
(86) PCT No.: PCT/EP2014/054848

§ 371 Date: Oct. 1, 2015

(30) Foreign Application Priority Data
Apr. 4, 2013 (DE) 10 2013 205 963.9

(51) Int. Cl. C08J 9/00

(52) U.S. Cl. CPC C08J 9/00; C08J 2333/24

(57) ABSTRACT

The present invention relates to a process for the continuous manufacture of PMI foam blocks. This has high flexibility in respect of the size of the blocks. This process begins by bonding the ends of individual prepolymerized PMI blocks to one another, preferably by means of hot-plate welding, and then passes the blocks into an NIR heating unit. The PMI polymer here foams continuously during passage through the said unit. The PMI foam is discharged at the end in the form of continuous material and can be cut or sawn into individual pieces of any desired length and shape. This process is advantageous in comparison with the continuous procedure in that the PMI foam material is almost stress-free and has a very uniform, closed-cell pore structure. At the same time, uniform density distribution is achieved over the thickness of the block, since the foaming procedure does not proceed from the outside to the centre of the block, but instead the volume of the polymer is increased uniformly.

### FIELD OF THE INVENTION

The present invention relates to a novel process for the continuous manufacture of PMI foam blocks. This process has high flexibility in respect of the size of the blocks. This novel process begins by bonding the ends of individual prepolymerized PMI blocks to one another, preferably by means of hot-plate welding, and then passes the blocks into an NIR heating unit. The PMI polymer here foams continuously during passage through the said unit. The PMI foam is discharged at the end in the form of continuous material and can be cut or sawn into individual pieces of any desired length and shape. This process is advantageous in comparison with the continuous procedure in that the PMI foam material is almost stress-free and has a very uniform, closed-cell pore structure. At the same time, uniform density distribution is achieved over the thickness of the block, since the foaming procedure does not proceed from the outside to the centre of the block, but instead the volume of the polymer is increased uniformly.

### PRIOR ART

It is known in the prior art that poly(meth)acrylimide foams (PMI foams) can be produced batchwise in the form of blocks. This process begins by copolymerizing (meth)acrylic acid and (meth)acrylonitrile to give a precursor which is already in appropriate sheet form. The copolymer is then subjected to ring closure to give the imide. A blowing agent present in the reaction mixture provides appropriate foaming on heating. For the purposes of this invention, the term (meth)acrylimide describes either methacrylimides or acrylimides. The same applies to the term (meth)acrylic acid, which comprises both acrylic acid and methacrylic acid. DE 1 817 156 has already described a process by which foamable plastics are produced in sheet form by polymerizing mixtures of methacrylonitrile and methacrylic acid between two glass plates sealed with a flexible bead. A blowing agent, namely formamide or monoalkylformamide, has already been added to the starting mixture. Free-radical generators are moreover present, for example in the form of a two-component mixture of tert-butyl perpivalate and benzoyl peroxide. The foaming of the individual sheets takes place thermally in an oven at a temperature of from 170 to 300° C. It is difficult to achieve uniform polymerization, since the temperature can very easily exceed the intended temperature. It is therefore necessary to monitor temperature variations very precisely and use alternating cooling or heating phases to compensate these. This mostly leads to irregular pores and to stresses within the foam matrix. In particular, disadvantages of this type occur to a greater extent when the thickness of polymer sheets is greater than 30 mm.

EP 1 175 458 describes isothermal production of thick blocks. This is achieved by using at least four different initiators. The initiator described as active at the highest temperature has a half-life time of 1 h at from 115° C. to 125° C. and acts primarily during a final conditioning process, rather than during the foaming process. This process, too, comprises batchwise foaming in an oven. Furthermore, although this process can foam relatively thick materials, because the foaming proceeds inwards from the outside, an insulating layer forms at the surface and retards the heating of the centre of the block, and in the case of very thick blocks likewise leads to an irregular pore structure and to stresses in the material.

DE 3 630 930 (Rohm GmbH) describes another process for foaming the abovementioned copolymer sheets made of methacrylic acid and methacrylonitrile. Here, the sheets are foamed with the aid of a microwave field. A factor that has to be considered here is that the sheet to be foamed, or at least the surface thereof, must be heated in advance up to or above the softening point of the material. These conditions naturally also cause onset of foaming of the material softened by the external heating, and it is therefore impossible to control the foaming process solely by using the effect of a microwave field, and additional external control is required from an ancillary heating system. The normal single-stage hot-air process is therefore supplemented by a microwave field in order to accelerate foaming. However, the microwave process has proved to be excessively complicated and therefore irrelevant for practical purposes, and currently remains unused.

### OBJECT

In the light of the prior art discussed, it was therefore an object of the present invention to provide a novel process which can foam PMI blocks continuously. In particular, the intention is to permit foaming of the blocks in the form of continuous material.

Another object of the present invention was to provide a process which can in particular foam thick PMI blocks to give a very uniform pore structure. The intention is to carry out the subsequent cooling process in a manner that avoids intrinsic thermal stress in the foam block, by conditioning of the foam.

A further intention is that the process is simple to carry out, saves energy, and requires no major capital expenditure. The process is also intended to be adaptable so as to permit achievement of comparable results with materials having different properties and having different thicknesses.

Other objects not explicitly discussed here can also be derived from the prior art, from the description, from the claims or from the inventive examples.

### ACHIEVEMENT OF OBJECT

The objects described are achieved through a novel process for foaming P(M)I blocks by foaming P(M)I blocks by irradiation with NIR radiation with a wavelength of from 0.78 to 1.40 μm in an infra-red heating unit.

The expression P(M)I here means either polymethacrylimides (PMI) or polyacrylimides (PI). The term NIR radiation means what is known as near-infra-red radiation. According to the invention, PMI blocks are preferred to PI blocks because of low residual monomer content and the markedly lower toxicity of the said residual monomers. These PMI foams are normally produced in a two-stage process: e.g. production of a cast polymer and foaming of this cast polymer. The present invention relates to this foaming of the cast polymer, but the invention is not to be interpreted as restricted to cast polymers, and can also be applied to alternative methods for producing P(M)I blocks.

Production of the cast polymer begins by producing monomer mixtures which comprise (meth)acrylic acid and (meth)acrylonitrile, preferably in a molar ratio of from 2:3 to 3:2, as main constituents. It is also possible to use other comonomers, e.g. esters of acrylic or of methacrylic acid, styrene, maleic acid or itaconic acid or anhydrides thereof or vinylpyrrolidone. However, the proportion of the comonomers here should not be more than 30% by weight. It is also possible to use small amounts of crosslinking monomers, e.g. allyl acrylate. However, the amounts should preferably be at most 0.05% by weight to 2.0% by weight.

The copolymerization mixture also comprises blowing agents which at temperatures of about 150 to 250° C. either decompose or vaporize and thus form a gas phase. The polymerization process takes place below this temperature, and the cast polymer therefore comprises a latent blowing agent. The polymerization process advantageously takes place in block form between two glass plates or by means of an in-mould-foaming process. The production of PMI blocks of this type for foaming is in principle known to the person skilled in the art and can be found by way of example in EP 1 444 293, EP 1 678 244 or WO 2011/138060. Acrylimide foams (PI foams) are considered to be analogous to PMI foams in terms of production and processing.

The process of the present invention in particular uses what is known as IR-A radiation, i.e. radiation in the short-wavelength region of NIR radiation. The wavelength of this radiation is from 0.78 to 1.40 μm.

In the process according to the invention it is preferable that the ends of a plurality of P(M)I blocks are bonded to one another prior to the irradiation with the NIR radiation mentioned. The irradiation with the NIR radiation then preferably takes place in a tunnel. It is therefore in particular possible to carry out the entire foaming process continuously.

It is particularly preferable that the ends of the P(M)I blocks are bonded to one another by means of hot-plate welding. An advantage of a welding process, in particular of a hot-plate welding process, in comparison with an adhesive bonding process here is that this joint is preferably no longer discernible in the P(M)I foam blocks subsequently obtained, and production of continuous material by continuous operation of the claimed process actually gives a material with a uniform quality.

It is preferable that the claimed process has the following steps:
a) hot-plate welding for bonding the ends of P(M)I blocks,
b) transferring the PMI blocks into an infra-red heating unit, and this transfer in particular takes place continuously,
c) passage through the infra-red heating unit and irradiation with NIR radiation in the wavelength range mentioned for controlled foaming,
c1) optional subsequent, uniform cooling to avoid thermal stress due to cooling,
d) sawing or cutting the foamed P(M)I blocks apart, e.g. to a desired length, and
e) optionally cooling further and removing the finished block product.

It is preferable that the cooling of the foamed block product takes place in step c1). However, it is also possible as an alternative to delay complete cooling to step e) or to carry out cooling in step c1) to a slightly increased temperature and finally to carry out cooling in step e) to a removal temperature.

It is preferable that the intensity distribution of the NIR radiation in the infra-red heating unit is selected in such a way as to achieve the highest radiation intensity in the centre of the P(M)I block. This can be achieved through individual controllable/regulatable infra-red sources in the infra-red heating unit. Local differences in intensity distribution are thus possible.

A further improvement in the quality of the foam can be achieved by passing the material, between step c) and step d), through an oven in which the PMI foam is conditioned. This oven can likewise have been equipped with NIR lamps. However, it is generally a conventional oven, without any radiation source. In this type of variant, the material in particular passes through the cooling step in step e), irrespective of whether the optional step c1) has been carried out or not.

A major advantage of the claimed process is that it can be carried out in an environmentally compatible manner and with very short cycle times, while at the same time combining a plurality of operations within a process. Surprisingly, it has been found that the non-aggressive heating of the material in step c) can bring about plastic deformability through uniform heat input, while avoiding any adverse effects on the material. Rapid and, in particular, uniform foaming is therefore possible. In particular, correct conduct of the present process avoids the adverse effects that can be observed by way of example on heating in an oven and that affect the subsequent surface of a rigid foam. The thermal radiation in the NIR spectral region used undergoes no absorption while penetrating the gas phase of the foam cells as they form, and brings about direct heating of the P(M)I, inclusive of the cell-wall matrix that is being formed.

The claimed process can be carried out with short cycle times, economically and in an environmentally compatible manner. Because the heating by the radiation mentioned can be carried out relatively rapidly, and in particular if the temperature distribution and intensity distribution associated with the NIR radiation are suitable, where the person skilled in the art required little resource to derive this suitable distribution, the heat distribution achieved in the entire workpiece is uniform, avoiding stress. The intensity of the radiation here can be varied within the range mentioned as required by the P(M)I used, and in particular can be varied in relation to the thickness of material used.

In one particular embodiment of the invention, the individual P(M)I foam blocks are transferred after step d) or e) into a further shaping mould for further processing. To this end, prior to transfer into the shaping mould the individual P(M)I foam blocks can be separated by means of a horizontal saw cut to give slab product. The said shaping mould can by way of example be used to produce, from the foam blocks or from slabs produced therefrom, composite materials with one or two outer layers, for example made of fibre-reinforced thermoplastic or resins. As an alternative, or in addition, the P(M)I foam blocks or slabs produced therefrom can be compacted to some extent or converted to a usage form, for example an open hollow profile. It is also possible by way of example to produce closed hollow profiles from two P(M)I foams thus shaped.

In one very particular embodiment of the present invention, the shaping mould has equally been equipped with NIR heating technology. Details of this type of shaping process can be found in the provisional application US 61/675,011.

The present invention also provides, in addition to the process described, P(M)I foam materials produced by the claimed process. A feature of these P(M)I foam materials in comparison with corresponding materials of the prior art is that they exhibit very uniform pore structure and relatively little thermal impairment, e.g. in relation to yellowing.

In principle, the P(M)I foams produced according to the invention are very versatile. Particular examples of application sectors are automobile construction—for example in the construction of bodywork or in interior cladding—aerospace technology, shipbuilding, construction of rail vehicles, mechanical engineering, medical technology, the furniture industry, in battery boxes, in lift construction, air ducts in air-conditioning systems, or in the construction of wind turbines, e.g. in the form of aerodynamic module in wind-turbine rotor blades.

The PMI foam material produced according to the invention can also comprise the following as required by intended use: fire-protection additives, colorants, inorganic fillers and/or process additives.

### EXAMPLE

Continuous foaming of PMI block polymer:

PMI block polymer, in this case ROHACELL RIMA, was foamed continuously at a thickness of 33 mm with a throughput speed of 5 cm/min in a heating section equipped with NIR sources. Surface temperatures were in the region of the foaming temperature at 200° C. and the intensity of the IR heating field was about 50% of maximum power.

Surprisingly, the foaming procedure was successfully controlled through appropriate selection of temperature and intensity in such a way that foaming of the block polymer proceeded from the inside outwards.

1: A process for foaming P(M)I blocks, comprising:
foaming the P(M)I blocks by irradiation with near-infra-red (NIR) radiation having a wavelength of from 0.78 to 1.40 μm in an infra-red heating unit.

2: The process according to claim 1, wherein:
the ends of the P(M)I blocks are bonded to one another prior to the irradiation with NIR radiation,
the irradiation with NIR radiation takes place in a tunnel, and
the foaming is carried out continuously.

3: The process according to claim 2, wherein the ends of the P(M)I blocks are bonded to one another by hot-plate welding.

4: The process according to claim 1, further comprising:
hot-plate welding to bond the ends of the P(M)I blocks,
transferring the P(M)I blocks into the infra-red heating unit,
controlled foaming the P(M)I blocks bypassaging the P(M)I blocks through the infra-red heating unit and the irradiation with NIR radiation to form foamed P(M)I blocks,
sawing or cutting the foamed P(M)I blocks apart into a plurality of finished block products, and
optionally cooling and removing the finished block products.

5: The process according to claim 4, further comprising uniformly cooling the P(M)I blocks after the controlled foaming.

6: The process according to claim 1, wherein the infra-red heating unit comprises NIR lamps and the NIR lamps are arranged such that the highest radiation intensity is achieved in the center of the P(M)I blocks.

7: The process according to claim 1, further comprising:
producing the P(M)I blocks continuously.

8: The process according to claim 1, wherein the foaming produces foamed P(M)I blocks.

9: The process according to claim 4, wherein between the controlled foaming and the sawing or cutting, a P(M)I foam material passes through an oven in which the P(M)I foam is conditioned.

10: The process according to claim 4, further comprising:
transferring the foamed P(M)I blocks into a shaping mould after the sawing or cutting or after the optional cooling and removing.

11: The process according to claim 10, further comprising:
separating the P(M)I foam blocks, prior to the transferring, with a horizontal saw cut into slab products.

12: The process according to claim 10, wherein the shaping mould is equipped with NIR heating technology.

13: The process according to claim 1, wherein the P(M)I blocks comprise at least one selected from the group consisting of fire-protection additives, colorants, inorganic fillers and process additives.

14: A P(M)I foam material produced by the process according to claim 1.

15: The process according to claim 2, wherein the infra-red heating unit comprises NIR lamps and the NIR lamps are arranged such that the highest radiation intensity is achieved in the center of the P(M)I blocks.

16: The process according to claim 2, further comprising:
producing the P(M)I blcoks continuously.

17: The process according to claim 2, wherein the foaming procures foamed P(M)I blocks.

18: The process according to claim 2, wherein the P(M)I blocks comprise at least one selected from the group consisting of fire-protection additives, colorants, inorganic fillers and process additives.
